(19) United States
(12) Patent Application Publication
(10) Pub. No.: US 2025/0254736 A1
(43) Pub. Date: Aug. 7, 2025

(54) NETWORK INITIATED RANDOM ACCESS IN WIRELESS COMMUNICATION SYSTEMS

(71) Applicant: Samsung Electronics Co., Ltd., Suwon-si (KR)

(72) Inventors: Anil Agiwal, McKinney, TX (US); Shiyang Leng, Allen, TX (US); Kyeongin Jeong, Allen, TX (US)

(21) Appl. No.: 19/036,803

(22) Filed: Jan. 24, 2025

Related U.S. Application Data
(60) Provisional application No. 63/548,686, filed on Feb. 1, 2024.
(60) Provisional application No. 63/553,312, filed on Feb. 14, 2024.

(51) Int. Cl. H04W 74/0838; H04W 72/02; H04W 72/0457; H04W 72/54

(52) U.S. Cl. CPC H04W 74/0838; H04W 72/02; H04W 72/0457; H04W 72/54

(57) ABSTRACT

A user equipment (UE) includes a transceiver. The transceiver is configured to receive, from a base station (BS), uplink (UL) bandwidth part (BWP) configurations for a plurality of UL BWPs of a cell, each of the UL BWP configurations including a random access (RA) configuration. The UE also includes a processor operatively coupled to the transceiver. The processor is configured to determine UL BWP selection information, and select, based on the UL BWP selection information, an UL BWP from the plurality UL BWPs for an RA procedure. The transceiver is also configured to transmit an RA preamble in an RA channel (RACH) occasion of the selected UL BWP.

### CROSS-REFERENCE TO RELATED APPLICATION(S) AND CLAIM OF PRIORITY

This application claims priority under 35 U.S.C. § 119 (e) to U.S. Provisional Patent Application No. 63/548,686 filed on Feb. 1, 2024, and U.S. Provisional Patent Application No. 63/553,312 filed on Feb. 14, 2024. The above-identified provisional patent applications are hereby incorporated by reference in their entirety.

### TECHNICAL FIELD

This disclosure relates generally to wireless networks. More specifically, this disclosure relates to network initiated random access.

### BACKGROUND

The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage is of paramount importance.

To meet the demand for wireless data traffic having increased since deployment of 4G communication systems, and to enable various vertical applications, 5G communication systems have been developed and are currently being deployed. The enablers for the 5G/NR mobile communications include massive antenna technologies, from legacy cellular frequency bands up to high frequencies, to provide beamforming gain and support increased capacity, new waveform (e.g., a new radio access technology [RAT]) to flexibly accommodate various services/applications with different requirements, new multiple access schemes to support massive connections, and so on.

### SUMMARY

This disclosure provides apparatuses and methods for network initiated random access in a wireless communication system.

In one embodiment, a user equipment (UE) is provided. The UE includes a transceiver. The transceiver is configured to receive, from a base station (BS), uplink (UL) bandwidth part (BWP) configurations for a plurality of UL BWPs of a cell, each of the UL BWP configurations including a random access (RA) configuration. The UE also includes a processor operatively coupled to the transceiver. The processor is configured to determine UL BWP selection information, and select, based on the UL BWP selection information, an UL BWP from the plurality UL BWPs for an RA procedure. The transceiver is also configured to transmit an RA preamble in an RA channel (RACH) occasion of the selected UL BWP.

In another embodiment, a BS is provided. The BS includes a process, and a transceiver operatively coupled to the processor. The transceiver is configured to transmit, to a UE, UL BWP configurations for a plurality of UL BWPs of a cell, each of the UL BWP configurations including a RA configuration. The transceiver is also configured to transmit, to the UE, congestion information for the plurality of UL BWPs, and transmit, to the UE, a message including one of a command to initiate an RA, a paging message, a paging downlink control information (DCI), and a low power wakeup signal (LPWUS).

In a third embodiment, third independent claim rewritten in multiple sentences with no “comprising”

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to embodiments of the present disclosure;

FIGS. 2A and 2B illustrate example wireless transmit and receive paths according to embodiments of the present disclosure;

FIG. 3A illustrates an example UE according to embodiments of the present disclosure;

FIG. 3B illustrates an example gNB according to embodiments of the present disclosure;

FIG. 4 illustrates an example procedure for random access according to embodiments of the present disclosure;

FIG. 5 illustrates another example procedure for random access according to embodiments of the present disclosure;

FIG. 6 illustrates another example procedure for random access according to embodiments of the present disclosure;

FIG. 7 illustrates another example procedure for random access according to embodiments of the present disclosure;

FIG. 8 illustrates another example procedure for random access according to embodiments of the present disclosure;

FIG. 9 illustrates another example procedure for random access according to embodiments of the present disclosure;

FIG. 10 illustrates an example method for random access in a cell supporting multiple bandwidth parts according to embodiments of the present disclosure; and

FIG. 11 illustrates an example method for network initiated random access according to embodiments of the present disclosure.

### DETAILED DESCRIPTION

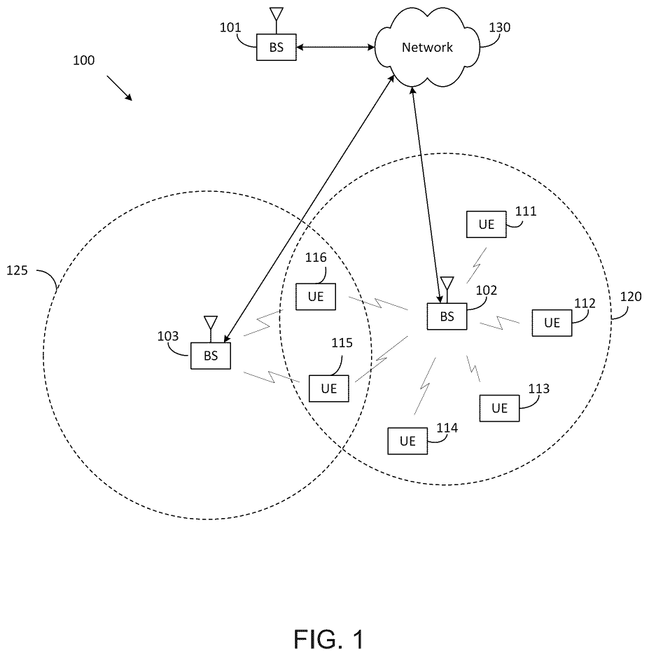

FIGS. 1 through 11, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHZ, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3B below describe various embodiments implemented in wireless communications systems and with the use of orthogonal frequency division multiplexing (OFDM) or orthogonal frequency division multiple access (OFDMA) communication techniques. The descriptions of FIGS. 1-3B are not meant to imply physical or architectural limitations to the manner in which different embodiments may be implemented. Different embodiments of the present disclosure may be implemented in any suitably arranged communications system.

FIG. 1 illustrates an example wireless network 100 according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for network initiated random access. In certain embodiments, one or more of the gNBs 101-103 includes circuitry, programing, or a combination thereof, to support network initiated random access in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

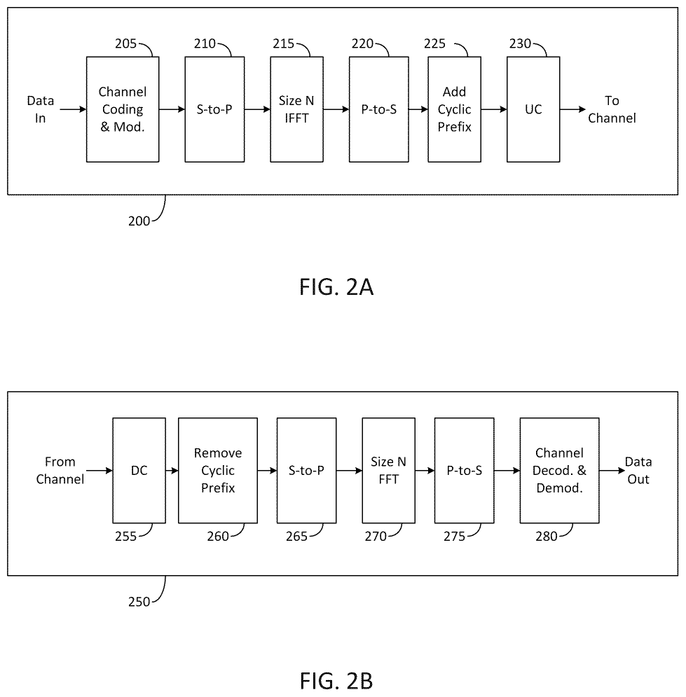

FIGS. 2A and 2B illustrate example wireless transmit and receive paths according to embodiments of the present disclosure. In the following description, a transmit path 200 may be described as being implemented in a gNB (such as gNB 102), while a receive path 250 may be described as being implemented in a UE (such as UE 116). However, it will be understood that the receive path 250 can be implemented in a gNB and that the transmit path 200 can be implemented in a UE. In some embodiments, the transmit path 200 and/or the receive path 250 is configured to implement and/or support network initiated random access as described in embodiments of the present disclosure.

The transmit path 200 includes a channel coding and modulation block 205, a serial-to-parallel (S-to-P) block 210, a size N Inverse Fast Fourier Transform (IFFT) block 215, a parallel-to-serial (P-to-S) block 220, an add cyclic prefix block 225, and an up-converter (UC) 230. The receive path 250 includes a down-converter (DC) 255, a remove cyclic prefix block 260, a serial-to-parallel (S-to-P) block 265, a size N Fast Fourier Transform (FFT) block 270, a parallel-to-serial (P-to-S) block 275, and a channel decoding and demodulation block 280.

In the transmit path 200, the channel coding and modulation block 205 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 210 converts (such as de-multiplexes) the serial modulated symbols to parallel data in order to generate N parallel symbol streams, where N is the IFFT/FFT size used in the gNB 102 and the UE 116. The size N IFFT block 215 performs an IFFT operation on the N parallel symbol streams to generate time-domain output signals. The parallel-to-serial block 220 converts (such as multiplexes) the parallel time-domain output symbols from the size N IFFT block 215 in order to generate a serial time-domain signal. The add cyclic prefix block 225 inserts a cyclic prefix to the time-domain signal. The up-converter 230 modulates (such as up-converts) the output of the add cyclic prefix block 225 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116. The down-converter 255 down-converts the received signal to a baseband frequency, and the remove cyclic prefix block 260 removes the cyclic prefix to generate a serial time-domain baseband signal. The serial-to-parallel block 265 converts the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream.

Each of the gNBs 101-103 may implement a transmit path 200 that is analogous to transmitting in the downlink to UEs 111-116 and may implement a receive path 250 that is analogous to receiving in the uplink from UEs 111-116. Similarly, each of UEs 111-116 may implement a transmit path 200 for transmitting in the uplink to gNBs 101-103 and may implement a receive path 250 for receiving in the downlink from gNBs 101-103.

Each of the components in FIGS. 2A and 2B can be implemented using only hardware or using a combination of hardware and software/firmware. As a particular example, at least some of the components in FIGS. 2A and 2B may be implemented in software, while other components may be implemented by configurable hardware or a mixture of software and configurable hardware. For instance, the FFT block 270 and the IFFT block 215 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 2A and 2B illustrate examples of wireless transmit and receive paths, various changes may be made to FIGS. 2A and 2B. For example, various components in FIGS. 2A and 2B can be combined, further subdivided, or omitted and additional components can be added according to particular needs. Also, FIGS. 2A and 2B are meant to illustrate examples of the types of transmit and receive paths that can be used in a wireless network. Any other suitable architectures can be used to support wireless communications in a wireless network.

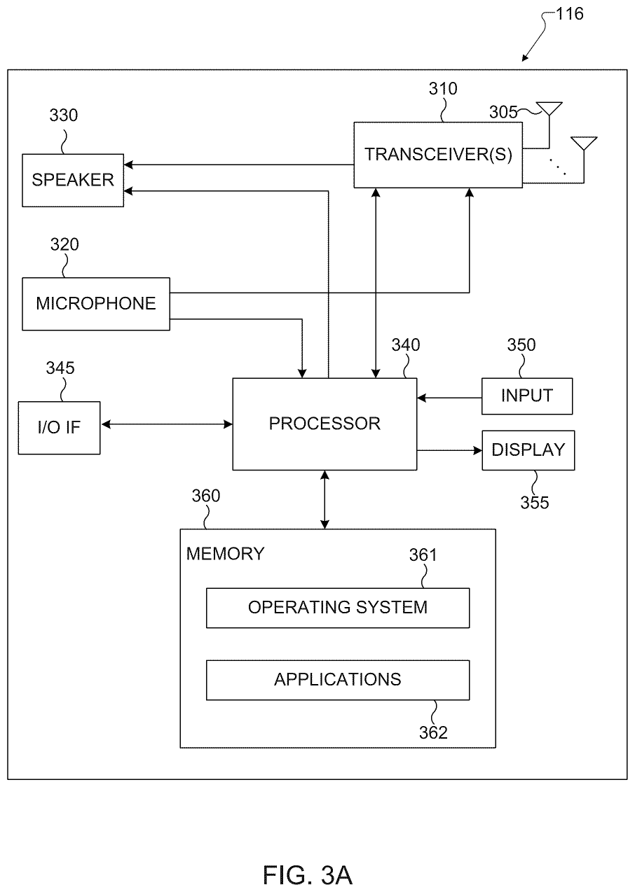

FIG. 3A illustrates an example UE 116 according to embodiments of the present disclosure. The embodiment of the UE 116 illustrated in FIG. 3A is for illustration only, and the UEs 111-115 of FIG. 1 could have the same or similar configuration. However, UEs come in a wide variety of configurations, and FIG. 3A does not limit the scope of this disclosure to any particular implementation of a UE.

As shown in FIG. 3A, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, for example, processes for network initiated random access as discussed in greater detail below. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3A illustrates one example of UE 116, various changes may be made to FIG. 3A. For example, various components in FIG. 3A could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3A illustrates the UE 116 configured as a mobile telephone or smartphone, UEs could be configured to operate as other types of mobile or stationary devices.

FIG. 3B illustrates an example gNB 102 according to embodiments of the present disclosure. The embodiment of the gNB 102 illustrated in FIG. 3B is for illustration only, and the gNBs 101 and 103 of FIG. 1 could have the same or similar configuration. However, gNBs come in a wide variety of configurations, and FIG. 3B does not limit the scope of this disclosure to any particular implementation of a gNB.

As shown in FIG. 3B, the gNB 102 includes multiple antennas 370a-370n, multiple transceivers 372a-372n, a controller/processor 378, a memory 380, and a backhaul or network interface 382.

The transceivers 372a-372n receive, from the antennas 370a-370n, incoming RF signals, such as signals transmitted by UEs in the network 100. The transceivers 372a-372n down-convert the incoming RF signals to generate IF or baseband signals. The IF or baseband signals are processed by receive (RX) processing circuitry in the transceivers 372a-372n and/or controller/processor 378, which generates processed baseband signals by filtering, decoding, and/or digitizing the baseband or IF signals. The controller/processor 378 may further process the baseband signals.

Transmit (TX) processing circuitry in the transceivers 372a-372n and/or controller/processor 378 receives analog or digital data (such as voice data, web data, e-mail, or interactive video game data) from the controller/processor 378. The TX processing circuitry encodes, multiplexes, and/or digitizes the outgoing baseband data to generate processed baseband or IF signals. The transceivers 372a-372n up-converts the baseband or IF signals to RF signals that are transmitted via the antennas 370a-370n.

The controller/processor 378 can include one or more processors or other processing devices that control the overall operation of the gNB 102. For example, the controller/processor 378 could control the reception of uplink (UL) channel signals and the transmission of downlink (DL) channel signals by the transceivers 372a-372n in accordance with well-known principles. The controller/processor 378 could support additional functions as well, such as more advanced wireless communication functions. For instance, the controller/processor 378 could support beam forming or directional routing operations in which outgoing/incoming signals from/to multiple antennas 370a-370n are weighted differently to effectively steer the outgoing signals in a desired direction. Any of a wide variety of other functions could be supported in the gNB 102 by the controller/processor 378.

The controller/processor 378 is also capable of executing programs and other processes resident in the memory 380, such as an OS and, for example, processes to support network initiated random access as discussed in greater detail below. The controller/processor 378 can move data into or out of the memory 380 as required by an executing process.

The controller/processor 378 is also coupled to the backhaul or network interface 382. The backhaul or network interface 382 allows the gNB 102 to communicate with other devices or systems over a backhaul connection or over a network. The interface 382 could support communications over any suitable wired or wireless connection(s). For example, when the gNB 102 is implemented as part of a cellular communication system (such as one supporting 5G/NR, LTE, or LTE-A), the interface 382 could allow the gNB 102 to communicate with other gNBs over a wired or wireless backhaul connection. When the gNB 102 is implemented as an access point, the interface 382 could allow the gNB 102 to communicate over a wired or wireless local area network or over a wired or wireless connection to a larger network (such as the Internet). The interface 382 includes any suitable structure supporting communications over a wired or wireless connection, such as an Ethernet or transceiver.

The memory 380 is coupled to the controller/processor 378. Part of the memory 380 could include a RAM, and another part of the memory 380 could include a Flash memory or other ROM.

Although FIG. 3B illustrates one example of gNB 102, various changes may be made to FIG. 3B. For example, the gNB 102 could include any number of each component shown in FIG. 3B. Also, various components in FIG. 3B could be combined, further subdivided, or omitted and additional components could be added according to particular needs.

In the next generation wireless communication system (e.g., 5G, beyond 5G (B5G), 6G) operating in higher frequency (mmWave) bands, UEs and gNBs communicate with each other using beamforming. Beamforming techniques are used to mitigate the propagation path losses and to increase the propagation distance for communication at higher frequency bands. Beamforming enhances the transmission and reception performance using a high-gain antenna. Beamforming can be classified into Transmission (TX) beamforming performed in a transmitting end and reception (RX) beamforming performed in a receiving end. In general, TX beamforming increases directivity by allowing an area in which propagation reaches to be densely located in a specific direction by using a plurality of antennas. In this situation, aggregation of the plurality of antennas can be referred to as an antenna array, and each antenna included in the array can be referred to as an array element. The antenna array can be configured in various forms such as a linear array, a planar array, etc. The use of TX beamforming results in an increase in the directivity of a signal, thereby increasing the propagation distance. Further, since the signal is almost not transmitted in a direction other than a directivity direction, a signal interference acting on another receiving end is significantly decreased. The receiving end can perform beamforming on an RX signal by using an RX antenna array. RX beamforming increases the RX signal strength transmitted in a specific direction by allowing propagation to be concentrated in a specific direction, and excludes a signal transmitted in a direction other than the specific direction from the RX signal, thereby providing an effect of blocking an interference signal. By using beamforming techniques, a transmitter can generate a plurality of transmit beam patterns of different directions. Each of these transmit beam patterns can also be referred to as a transmit (TX) beam. A wireless communication system operating at high frequency uses a plurality of narrow TX beams to transmit signals in the cell, as each narrow TX beam provides coverage to a part of the cell. The narrower the TX beam, the higher the antenna gain and hence the larger the propagation distance of a signal transmitted using beamforming. A receiver can also generate a plurality of receive (RX) beam patterns of different directions. Each of these receive patterns can also be referred to as a receive (RX) beam.

The next generation wireless communication system (e.g., 5G, beyond 5G (B5G), 6G) supports standalone modes of operation as well dual connectivity (DC). In DC a multiple Rx/Tx UE may be configured to utilize resources provided by two different nodes (or NBs) connected via non-ideal backhaul. One node acts as the Master Node (MN) and the other as the Secondary Node (SN). The MN and SN are connected via a network interface and at least the MN is connected to the core network. NR also supports Multi-RAT Dual Connectivity (MR-DC) operation whereby a UE in an RRC_CONNECTED state is configured to utilize radio resources provided by two distinct schedulers, located in two different nodes connected via a non-ideal backhaul and providing either E-UTRA (i.e., if the node is an ng-eNB) or NR access (i.e., if the node is a gNB). In NR for a UE in an RRC_CONNECTED state not configured with carrier aggregation (CA)/DC there is only one serving cell comprising the primary cell (PCell). For a UE in an RRC_CONNECTED state configured with CA/DC the term ‘serving cells’ is used to denote the set of cells comprising of the Special Cell(s) (SpCells) and all secondary cells (SCells). In NR the term Master Cell Group (MCG) refers to a group of serving cells associated with the Master Node, comprising a PCell and optionally one or more SCells. In NR the term Secondary Cell Group (SCG) refers to a group of serving cells associated with the Secondary Node, comprising the Primary SCG Cell (PSCell) and optionally one or more SCells. In NR PCell refers to a serving cell in MCG, operating on the primary frequency, in which the UE either performs the initial connection establishment procedure or initiates the connection re-establishment procedure. In NR for a UE configured with CA, an SCell is a cell providing additional radio resources on top of a SpCell. PSCell refers to a serving cell in an SCG in which the UE performs random access when performing the Reconfiguration with Sync procedure. For Dual Connectivity operation the term SpCell refers to the PCell of the MCG or the PSCell of the SCG, otherwise the term SpCell refers to the PCell.

In the next generation wireless communication system (e.g., 5G, beyond 5G (B5G), 6G), a node B (gNB) or base station in cell broadcast Synchronization Signal and PBCH block (SSB), also referred to herein as a Synchronization Signal Block, comprises primary and secondary synchronization signals (PSS, SSS) and system information. System information includes common parameters needed to communicate in a cell. In the fifth generation wireless communication system (also referred as next generation radio or NR), System Information (SI) is divided into the master information block (MIB) and a number of system information blocks (SIBs) wherein the MIB is transmitted on the broadcast channel (BCH) with a periodicity of 80 ms and repetitions made within 80 ms and it includes parameters that are needed to acquire SIB1 from the cell. The SIB1 is transmitted on the downlink shared channel (DL-SCH) with a periodicity of 160 ms and variable transmission repetition. The default transmission repetition periodicity of SIB1 is 20 ms but the actual transmission repetition periodicity is up to network implementation. For SSB and CORESET multiplexing pattern 1, the SIB1 repetition transmission period is 20 ms. For SSB and CORESET multiplexing pattern 2/3, the SIB1 transmission repetition period is the same as the SSB period. SIB1 includes information regarding the availability and scheduling (e.g., mapping of SIBs to SI message, periodicity, SI-window size) of other SIBs with an indication whether one or more SIBs are only provided on-demand and, in that case, the configuration needed by the UE to perform the SI request. SIB1 is a cell-specific SIB; SIBs other than SIB1 and posSIBs are carried in SystemInformation (SI) messages, which are transmitted on the DL-SCH. Only SIBs or posSIBs having the same periodicity can be mapped to the same SI message. SIBs and posSIBs are mapped to different SI messages. Each SI message is transmitted within periodically occurring time domain windows (referred to as SI-windows with same length for all SI messages). Each SI message is associated with an SI-window and the SI-windows of different SI messages do not overlap. That is, within one SI-window only the corresponding SI message is transmitted. An SI message may be transmitted a number of times within the SI-window. Any SIB or posSIB except SIB1 can be configured to be cell specific or area specific, using an indication in SIB1. The cell specific SIB is applicable only within a cell that provides the SIB while the area specific SIB is applicable within an area referred to as an SI area, which comprises one or several cells and is identified by systemInformationArealD. The mapping of SIBs to SI messages is configured in schedulingInfoList, while the mapping of posSIBs to SI messages is configured in pos-SchedulingInfoList. Each SIB is contained only in a single SI message and each SIB and posSIB is contained at most once in that SI message; For a UE in RRC_CONNECTED, the network can provide system information through dedicated signaling using the RRCReconfiguration message (e.g., if the UE has an active BWP with no common search space configured to monitor system information), paging, or upon request from the UE. In an RRC_CONNECTED state, the UE acquires the requested SIB(s) only from the PCell. For PSCell and SCells, the network provides the required SI by dedicated signaling (i.e., within an RRCReconfiguration message). Nevertheless, the UE acquires the MIB of the PSCell to get system frame number (SFN) timing of the SCG (which may be different from the MCG). Upon change of relevant SI for the SCell, the network releases and adds the concerned SCell. For the PSCell, the SI can only be changed with Reconfiguration with Sync.

In the next generation wireless communication system (e.g., 5G, beyond 5G (B5G), 6G), a Physical Downlink Control Channel (PDCCH) is used to schedule DL transmissions on the Physical Downlink Shared Channel (PDSCH) and UL transmissions on the Physical Uplink Shared Channel (PUSCH), where the Downlink Control Information (DCI) on PDCCH includes: downlink assignments containing at least modulation and coding format, resource allocation, and hybrid-ARQ information related to DL-SCH; uplink scheduling grants containing at least modulation and coding format, resource allocation, and hybrid-ARQ information related to UL-SCH. In addition to scheduling, the PDCCH can be used to for: activation and deactivation of configured PUSCH transmission with configured grant; activation and deactivation of PDSCH semi-persistent transmission; notifying one or more UEs of the slot format; notifying one or more UEs of the PRB(s) and OFDM symbol(s) where the UE may assume no transmission is intended for the UE; transmission of TPC commands for PUCCH and PUSCH; transmission of one or more TPC commands for SRS transmissions by one or more UEs; switching a UE's active bandwidth part; and initiating a random access procedure. A UE monitors a set of PDCCH candidates in the configured monitoring occasions in one or more configured COntrol REsource SETs (CORESETs) according to the corresponding search space configurations. A CORESET comprises a set of PRBs with a time duration of 1 to 3 OFDM symbols. The resource units Resource Element Groups (REGs) and Control Channel Elements (CCEs) are defined within a CORESET with each CCE comprising a set of REGs. Control channels are formed by aggregation of CCEs. Different code rates for the control channels are realized by aggregating different numbers of CCEs. Interleaved and non-interleaved CCE-to-REG mapping is supported in a CORESET. Polar coding is used for the PDCCH. Each resource element group carrying the PDCCH carries its own demodulation reference signal (DMRS). Quadrature phase shift keying (QPSK) modulation is used for PDCCH.

In the next generation wireless communication system (e.g., 5G, beyond 5G (B5G), 6G), a list of search space configurations is signaled by the gNB for each configured bandwidth part (BWP) of the serving cell, wherein each search configuration is uniquely identified by a search space identifier. The search space identifier is unique amongst the BWPs of a serving cell. An identifier of search space configuration to be used for specific purpose such as paging reception, SI reception, random access response reception is explicitly signaled by the gNB for each configured BWP. In NR, a search space configuration comprises the parameters Monitoring-periodicity-PDCCH-slot, Monitoring-offset-PDCCH-slot, Monitoring-symbols-PDCCH-within-slot and duration. A UE determines PDCCH monitoring occasion(s) within a slot using the parameters PDCCH monitoring periodicity (Monitoring-periodicity-PDCCH-slot), the PDCCH monitoring offset (Monitoring-offset-PDCCH-slot), and the PDCCH monitoring pattern (Monitoring-symbols-PDCCH-within-slot). PDCCH monitoring occasions are in slots ‘x’ to x+duration where the slot with number ‘x’ in a radio frame with number ‘y’ satisfies the equation below:

(y*(number of slots in a radio frame)+x−Monitoring-offset-PDCCH-slot)mod(Monitoring-periodicity-PDCCH-slot)=0.

The starting symbol of a PDCCH monitoring occasion in each slot having a PDCCH monitoring occasion is given by Monitoring-symbols-PDCCH-within-slot. The length (in symbols) of a PDCCH monitoring occasion is given in the CORESET associated with the search space. A search space configuration includes the identifier of a CORESET configuration associated with it. A list of CORESET configurations are signaled by the gNB for each configured BWP of a serving cell, wherein each CORESET configuration is uniquely identified by a CORESET identifier. The CORESET identifier is unique amongst the BWPs of a serving cell. Note that each radio frame is of 10 ms duration. A radio frame is identified by a radio frame number or system frame number. Each radio frame comprises several slots, wherein the number of slots in a radio frame and duration of slots depends on sub carrier spacing. The number of slots in a radio frame and duration of slots for each supported SCS is pre-defined in NR. Each CORESET configuration is associated with a list of TCI (Transmission configuration indicator) states. One DL reference signal (RS) identification (ID) (SSB or channel state information [CSI] RS) is configured per TCI state. The list of TCI states corresponding to a CORESET configuration is signaled by the gNB via RRC signaling. One of the TCI states in a TCI state list is activated and indicated to the UE by the gNB. The TCI state indicates the DL TX beam (the DL TX beam is QCLed with SSB/CSI RS of the TCI state) used by the gNB for transmission of the PDCCH in the PDCCH monitoring occasions of a search space.

In the next generation wireless communication system (e.g., 5G, beyond 5G (B5G), 6G), bandwidth adaptation (BA) is supported. With BA, the receive and transmit bandwidth of a UE need not be as large as the bandwidth of the cell and can be adjusted: the width can be ordered to change (e.g., to shrink during period of low activity to save power); the location can move in the frequency domain (e.g., to increase scheduling flexibility); and the subcarrier spacing can be ordered to change (e.g., to allow different services). A subset of the total cell bandwidth of a cell is referred to as a Bandwidth Part (BWP). BA is achieved by configuring an RRC connected UE with BWP(s) and telling the UE which of the configured BWPs is currently the active one. When BA is configured, the UE can monitor the PDCCH only on the one active BWP (i.e., the UE does not have to monitor the PDCCH on the entire DL frequency of the serving cell). In an RRC connected state, the UE is configured with one or more DL and UL BWPs, for each configured Serving Cell (i.e., PCell or SCell). For an activated Serving Cell, there is one active UL and DL BWP at any point in time. BWP switching for a Serving Cell is used to activate an inactive BWP and deactivate an active BWP at a time. BWP switching is controlled by the PDCCH indicating a downlink assignment or an uplink grant, by the bwp-InactivityTimer, by RRC signaling, or by the MAC entity itself upon initiation of a Random Access procedure. Upon addition of a SpCell or activation of an SCell, the DL BWP and UL BWP indicated by firstActiveDownlinkBWP-Id and firstActiveUplinkBWP-Id respectively is active without receiving a PDCCH indicating a downlink assignment or an uplink grant. The active BWP for a Serving Cell is indicated by either RRC or the PDCCH. For unpaired spectrum, a DL BWP is paired with a UL BWP, and BWP switching is common for both UL and DL. Upon expiry of the BWP inactivity timer, the UE switches the active DL BWP to the default DL BWP or initial DL BWP (if a default DL BWP is not configured).

In the next generation wireless communication system (e.g., 5G, beyond 5G (B5G), 6G), random access (RA) is supported. Random access (RA) is used to achieve uplink (UL) time synchronization. RA is used during initial access, handover, radio resource control (RRC) connection re-establishment procedure, scheduling request transmission, secondary cell group (SCG) addition/modification, beam failure recovery and data or control information transmission in UL by non-synchronized UEs in an RRC CONNECTED state. Several types of random access procedure are supported.

In contention based random access (CBRA), also referred to as 4 step CBRA, tje UE first transmits a Random Access preamble (also referred to as Msg1) and then waits for a Random access response (RAR) in the RAR window. The RAR is also referred to as Msg2. A next generation node B (gNB) transmits the RAR on the physical downlink shared channel (PDSCH). A PDCCH scheduling the PDSCH carrying the RAR is addressed to an RA-radio network temporary identifier (RA-RNTI). The RA-RNTI identifies the time-frequency resource (also referred to as a physical RA channel [PRACH] occasion or PRACH transmission [TX] occasion or RA channel [RACH] occasion) in which the RA preamble was detected by the gNB. The RA-RNTI is calculated as follows: RA-RNTI=1+s_id+14*t_id+14*80*f_id+14*80*8*ul_carrier_id, where s_id is the index of the first orthogonal frequency division multiplexing (OFDM) symbol of the PRACH occasion where the UE has transmitted Msg1, i.e., an RA preamble; 0≤s_id<14; t_id is the index of the first slot of the PRACH occasion (Og t_id<80); f_id is the index of the PRACH occasion within the slot in the frequency domain (0≤f_id<8), and ul_carrier_id is the UL carrier used for Msg1 transmission (0 for normal UL [NUL] carrier and 1 for supplementary UL [SUL] carrier. Several RARs for various Random-access preambles detected by the gNB can be multiplexed in the same RAR media access control (MAC) protocol data unit (PDU) by the gNB. A RAR in a MAC PDU corresponds to the UE's RA preamble transmission if the RAR includes an RA preamble identifier (RAPID) of the RA preamble transmitted by the UE. If the RAR corresponding to its RA preamble transmission is not received during the RAR window and the UE has not yet transmitted the RA preamble for a configurable (configured by the gNB in a RACH configuration) number of times, the UE goes back to the first step (i.e., select random access resource [preamble/RACH occasion]) and transmits the RA preamble. A backoff may be applied before going back to first step.

If the RAR corresponding to its RA preamble transmission is received the UE transmits message 3 (Msg3) in the UL grant received in the RAR. Msg3 includes a message such as an RRC connection request, RRC connection re-establishment request, RRC handover confirm, scheduling request, SI request etc. It may include the UE identity (i.e., cell-radio network temporary identifier [C-RNTI] or system architecture evolution [SAE]-temporary mobile subscriber identity [S-TMSI] or a random number). After transmitting the Msg3, the UE starts a contention resolution timer. While the contention resolution timer is running, if the UE receives a physical downlink control channel (PDCCH) addressed to the C-RNTI included in Msg3, contention resolution is considered successful, the contention resolution timer is stopped and the RA procedure is completed. While the contention resolution timer is running, if the UE receives a contention resolution MAC control element (CE) including the UE's contention resolution identity (first X bits of the common control channel [CCCH] service data unit [SDU] transmitted in Msg3), contention resolution is considered successful, the contention resolution timer is stopped and the RA procedure is completed. If the contention resolution timer expires and the UE has not yet transmitted the RA preamble for a configurable number of times, the UE goes back to the first step (i.e., select random access resource [preamble/RACH occasion]) and transmits the RA preamble. A backoff may be applied before going back to the first step.

For performing CBRA, a RACH configuration is signaled in system information (i.e., SIB 1) and in dedicated RRC signaling. The RACH configuration in SIB 1 is used by the UE in the RRC IDLE and RRC INACTIVE states.

A contention based RACH configuration includes prach-ConfigurationIndex which indicates the available set of PRACH occasions for the transmission of the Random Access Preamble. The number of PRACH occasions in the PRACH configuration period is pre-defined for each PRACH configuration index. A PRACH configuration period for each PRACH configuration index is also pre-defined. A pre-defined PRACH configuration table lists a number of configurations, wherein each configuration indicates a number of PRACH occasions in the PRACH configuration period, PRACH configuration period, and location of PRACH occasions in the PRACH configuration period. The PRACH configuration index is an index to an entry in this PRACH configuration table.

The contention based RACH configuration also includes ssb-perRACH-OccasionAndCB-PreamblesPerSSB. ssb-perRACH-OccasionAndCB-PreamblesPerSSB indicates CB-PreamblesPerSSB (R) and ssb-perRACH-Occasion (N).

Based on ssb-perRACH-Occasion and number of SSBs transmitted in the cell, PRACH occasions configured by prach-ConfigurationIndex are mapped to SSBs. The number of SSBs transmitted in cell is signaled by the gNB in system information and dedicated RRC signaling messages. PRACH occasions are mapped to SSBs over an association period. The association period starting from SFN 0 is the period in which all SSBs are mapped to PRACH occasions at least once. In an example, the association period can be equal to {1, 2, 4, 8, 16} PRACH Configuration periods.

If N<1, one SSB is mapped to 1/N consecutive valid PRACH occasions and R contention based preambles with consecutive indexes associated with the SSB per valid PRACH occasion start from preamble index 0. If N≥1, Rcontention based preambles with consecutive indexes associated with SSB n, 0≤n≤N−1, per valid PRACH occasion start from preamble index n·N_{preamble}^{total}/N where N_{preamble}^{total} is provided by totalNumberOfRA-Preambles and is an integer multiple of N. totalNumberOfRA-Preambles is signaled by the gNB in the RACH configuration.

Contention free random access (CFRA), also referred to as legacy CFRA or 4 step CFRA, is used for scenarios such as handover where low latency is required, timing advance establishment for secondary cell (Scell), etc. An evolved node B (eNB) assigns to the UE a dedicated Random access preamble. The UE transmits the dedicated RA preamble. The eNB transmits the RAR on a PDSCH addressed to the RA-RNTI. The RAR conveys the RA preamble identifier and timing alignment information. The RAR may also include an UL grant. The RAR is transmitted in a RAR window similar to contention-based RA (CBRA) procedure. The CFRA is considered successfully completed after receiving the RAR including the RA preamble identifier (RAPID) of the RA preamble transmitted by the UE. In case the RA is initiated for beam failure recovery, the CFRA is considered successfully completed if the PDCCH addressed to the C-RNTI is received in a search space for beam failure recovery. If the RAR window expires and the RA is not successfully completed and the UE has not yet transmitted the RA preamble for a configurable (configured by the gNB in a RACH configuration) number of times, the UE retransmits the RA preamble.

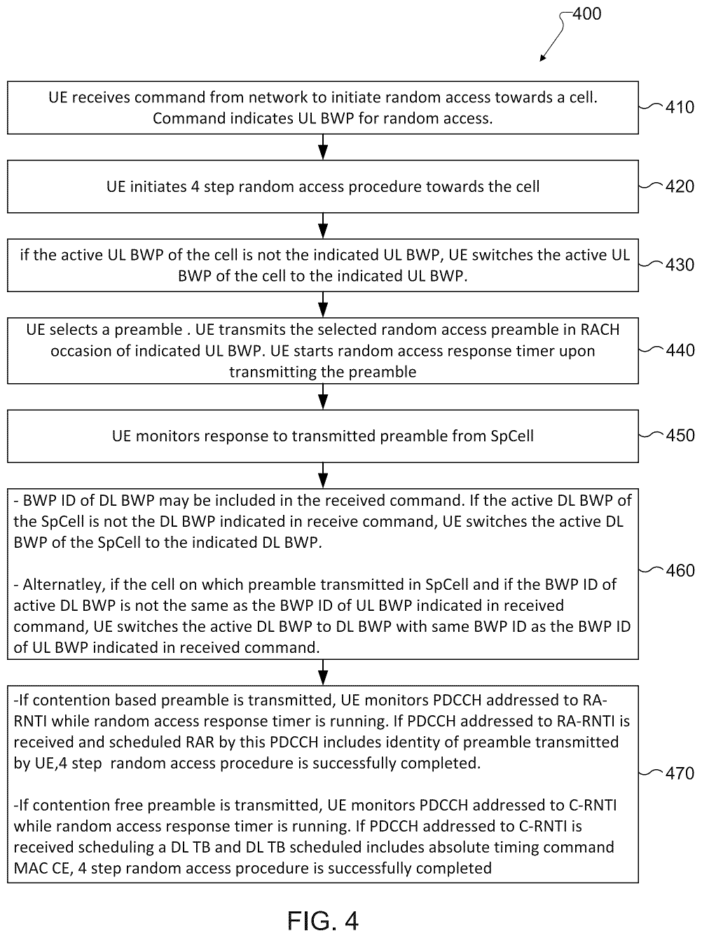

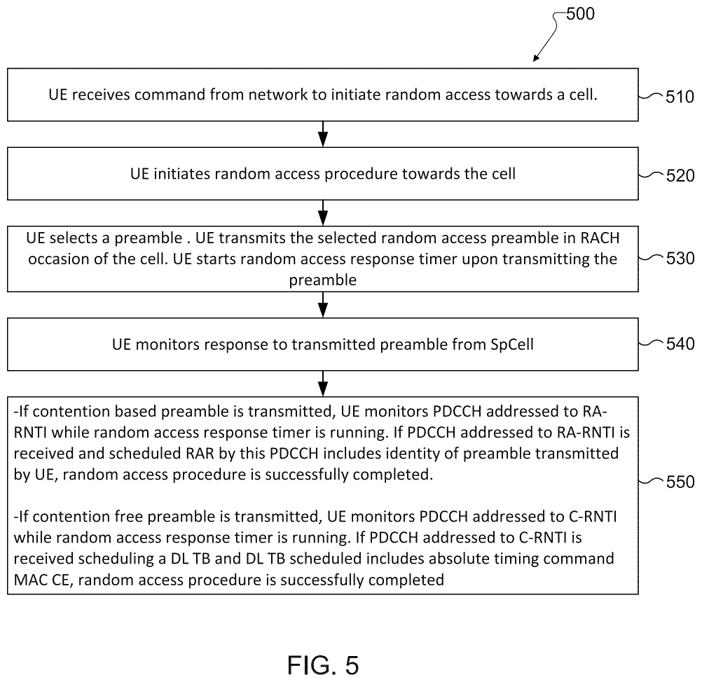

Under existing procedures, the network sends a PDCCH order for random access towards a serving cell. Upon receiving the PDCCH order, the UE initiates a random access procedure towards the serving cell. If the PRACH occasions are configured for the active UL BWP of the serving cell, the random access preamble is transmitted on the active UL BWP. If PRACH occasions are not configured for the active UL BWP of the serving cell, the random access preamble is transmitted on the initial UL BWP. The initial UL BWP is common for UEs in different RRC states (e.g., RRC IDLE/RRC_INACTIVE/RRC_CONENCTED). RACH occasions are configured for the initial UL BWP. If the UE's active UL BWP is the initial UL BWP, random access is performed on the initial UL BWP. If the UE's active UL BWP is not the initial UL BWP and RACH occasions are not configured on the active UL BWP, the random access is performed on the initial UL BWP. This may lead to contention amongst the UEs in different RRC states. If the network wants to distribute the random access load to different UL BWPs, the network has to first switch the active UL BWP of the UE by sending a BWP switching command, and then send a PDCCH order. This results in signaling overhead and delay. Various embodiments of the present disclosure, such as described regarding FIG. 5 and FIG. 6, provide for distributed random access load amongst different UL BWPs with reduced signaling overhead and delay compared to existing procedures.

Under existing procedures, if CFRA resources are provided in a PDCCH order for a 4 step random access procedure, the UE monitors for a PDCCH addressed to an RA-RNTI upon transmitting the contention free preamble. If the UE receives a PDCCH addressed to the RA-RNTI scheduling a RAR and the received RAR includes an identity of the transmitted preamble, the random access is considered successfully completed. However, a PDCCH addressed to an RA-RNTI is not UE specific. Therefore, it is possible that the RAR received by the UE is not intended for the UE, and the RAR will be discarded upon checking the preamble identity in RAR. This leads to unnecessary processing of the PDCCH and the PDSCH for a RAR. Various embodiments of the present disclosure, such as described regarding FIG. 5 and FIG. 6, provide for avoidance of unnecessary processing of the PDCCH and the PDSCH for a RAR.

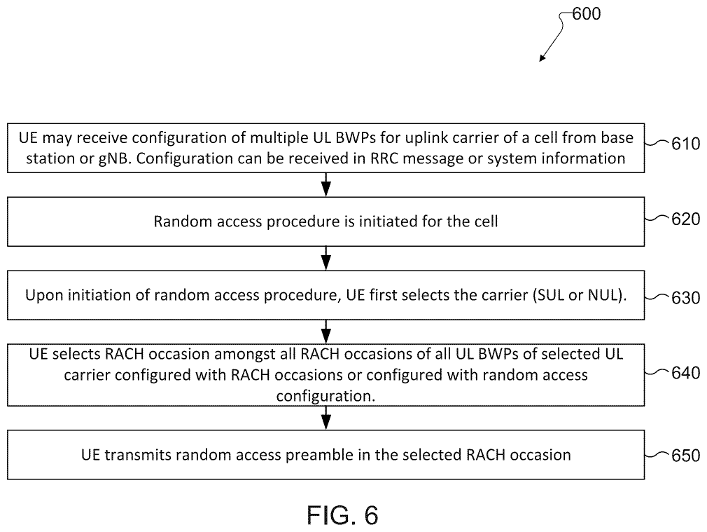

Under existing procedures, UEs in the RRC_IDLE and RRC INACTIVE states perform random access using an initial UL BWP and initial DL BWP. Several random access configurations can be configured in the initial UL BWP, wherein each random access configuration is associated with a feature or feature combination. The feature can be one of small data transmission, Msg3 repetition, Msg1 repetition, RedCap, eRedCap, slicing etc. Considering the limited bandwidth and/or time/frequency resources of the initial UL BWP, it is not possible or efficient to configure random access configurations for all features/feature combinations in the initial UL BWP. Various embodiments of the present disclosure, such as described regarding FIGS. 7-9, provide enhancement to support several random access configurations for various features/feature combination/use cases.

Under existing procedures, a UE in the RRC_CONNECTED state can be configured with multiple BWPs. Each of these BWPs can be configured with a random access configuration. The UE uses only the random access configuration in its active UL BWP. Even though random access resources may be available earlier in a BWP other than the active UL BWP, The UE cannot use these resources. Various embodiments of the present disclosure, such as described regarding FIGS. 7-9, provide for a UE to utilize available random access resources from a BWP other than the active UL BWP of the UE.

Under existing procedures, a UE in the RRC_CONNECTED state can be configured with multiple BWPs. Each of these BWPs can be configured with a random access configuration. UEs in the RRC_IDLE/RRC_INACTIVE state are not aware of these BWPs. Awareness of these BWPs in the RRC_IDLE/RRC_INACTIVE state may be beneficial to distribute random access load across these BWPs. Various embodiments of the present disclosure, such as described regarding FIGS. 7-9, provide for BWP awareness for a UE in the RRC_IDLE/RRC INACTIVE state.

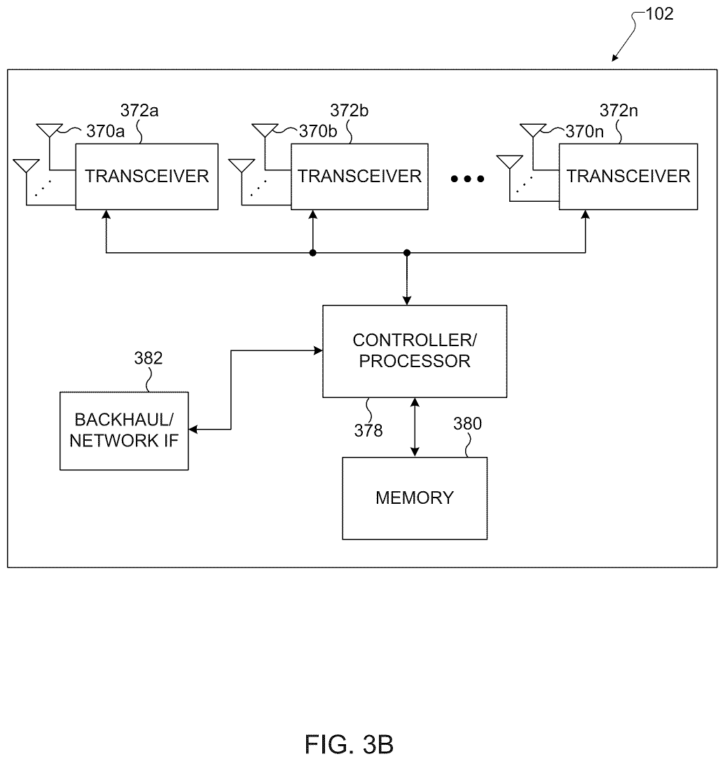

FIG. 4 illustrates an example procedure for random access 400 according to embodiments of the present disclosure. An embodiment of the procedure illustrated in FIG. 4 is for illustration only. One or more of the components illustrated in FIG. 4 may be implemented in specialized circuitry configured to perform the noted functions or one or more of the components may be implemented by one or more processors executing instructions to perform the noted functions. Other embodiments of a procedure for random access could be used without departing from the scope of this disclosure.

In the example of FIG. 4, procedure 400 begins at step 410. At step 410, a UE (such as UE 116 of FIG. 1) receives a command from the network (e.g., from a BS, nodeB, gNB, etc., such as BS 102 of FIG. 1) to initiate a random access towards a cell. In some embodiments, the cell can be an Scell. In some embodiments, the cell can be an SpCell. In some embodiments, the command can be a PDCCH order. In some embodiments, the cell can be indicated in the command. In some embodiments, the cell is the cell from which the UE has received the command. The Command indicates a UL BWP for random access. In some embodiments, the command may include a BWP ID to indicate the UL BWP for random access.

At step 420, upon receiving the command, the UE initiates a four step random access towards the cell.

At step 430, if the active UL BWP of the cell is not the UL BWP indicated in received command, the UE switches the active UL BWP of the cell to the indicated UL BWP.

At step 440, the UE selects a random access preamble. If a contention free random access preamble is included in the received command, the UE selects this random access preamble. Otherwise, the UE selects a random access preamble from contention based random access preambles of the indicated UL BWP of the cell. After making the selection, the UE transmits the selected random access preamble in a RACH occasion of the indicated UL BWP of the cell, and the UE starts a random access response timer upon transmitting the preamble.

In some embodiments, at step 450, the UE monitors for a response to the transmitted preamble from the SpCell. In these embodiments, the UE may perform the following operation(s) at step 460:

The BWP ID of the DL BWP may be included in the received command. If the active DL BWP of the cell is not the DL BWP indicated in the received command, the UE switches the active DL BWP of the cell to the indicated DL BWP. Alternately, if the BWP ID of the active DL BWP is not the same as the BWP ID of the UL BWP indicated in received command, the UE switches the active DL BWP to the DL BWP with the same BWP ID as the BWP ID of the UL BWP indicated in the received command.

In some embodiments, at step 450, the UE monitors for a response to the transmitted preamble from the SpCell. The cell on which the preamble is transmitted can be an SCell or the SpCell. In these embodiments, the UE may perform the following operation(s) at step 460:

The BWP ID of the DL BWP may be included in the received command. If the active DL BWP of the SpCell is not the DL BWP indicated in the received command, the UE switches the active DL BWP of the SpCell to the indicated DL BWP. Alternately, if the cell on which the preamble is transmitted is the SpCell, and if the BWP ID of active DL BWP is not the same as the BWP ID of UL BWP indicated in the received command, the UE switches the active DL BWP to the DL BWP with the same BWP ID as the BWP ID of the UL BWP indicated in received command.

In some embodiments, at step 450, the UE monitors for a response to the transmitted preamble from the cell in which the preamble is transmitted. In these embodiments, the UE may perform the following operation(s) at step 460:

The BWP ID of the DL BWP may be included in the received command. If the active DL BWP of the cell is not the DL BWP indicated in the received command, the UE switches the active DL BWP of the cell to the indicated DL BWP. Alternately, if the BWP ID of the active DL BWP is not the same as the BWP ID of the UL BWP indicated in the received command, the UE switches the active DL BWP to the DL BWP with the same BWP ID as the BWP ID of the UL BWP indicated in received command.

At step 470, the UE monitors for a response on the active DL BWP.

In some embodiments, the UE monitors for a PDCCH addressed to an RA-RNTI while the random access response timer is running. In these embodiments, if [1] a CFRA preamble is transmitted, [2] a PDCCH addressed to the RA-RNTI is received, and [3], a RAR scheduled by this PDCCH includes the identity of the preamble transmitted by the UE, the 4 step random access procedure is successfully completed. Otherwise, if [1] a CBRA preamble is transmitted, [2] a PDCCH addressed to the RA-RNTI is received, and [3] a RAR scheduled by this PDCCH includes the identity of the preamble transmitted by the UE, the random access response is considered successfully received, the UE transmits a Msg3 in an UL grant received in the RAR, the UE starts a contention resolution timer, and upon reception of a PDCCH addressed to a C-RNTI (scheduling a new UL or DL transmission) while the contention resolution timer is running, the 4 step random access procedure is successfully completed.

In some embodiments, if a CBRA preamble is transmitted, the UE monitors for a PDCCH addressed to an RA-RNTI while the random access response timer is running. If a PDCCH addressed to the RA-RNTI is received and a scheduled RAR by this PDCCH includes the identity of the preamble transmitted by the UE, the 4 step random access procedure is successfully completed. Otherwise, if a CFRA preamble is transmitted, the UE monitors for a PDCCH addressed to a C-RNTI while the random access response timer is running. If a PDCCH addressed to the C-RNTI is received scheduling a DL transport block (TB) and the DL TB scheduled includes an absolute timing advance (TA) command medium access control (MAC) control element (CE) (the absolute TA command MAC CE includes the absolute TA [not the TA adjustment]. The absolute TA command MAC CE may indicate the timing advance group [TAG] associated with the TA), the 4 step random access procedure is successfully completed.

In some embodiments, the BWP to be used for random access may not be included in the PDCCH order, and the BWP ID of the UL BWP (and/or DL BWP) to be used for random access is indicated to the UE via an RRC message (e.g., an RRCReconfiguration message). In these embodiments, the BWP ID refers to one of the multiple BWPs configured to the UE via the RRC message (e.g., an RRCReconfiguration message). This RRC message is received by the UE before receiving the PDCCH order.

Although FIG. 4 illustrates one example procedure for random access 400, various changes may be made to FIG. 4. For example, while shown as a series of steps, various steps in FIG. 4 could overlap, occur in parallel, occur in a different order, occur any number of times, be omitted, or replaced by other steps.

FIG. 5 illustrates another example procedure for random access 500 according to embodiments of the present disclosure. An embodiment of the procedure illustrated in FIG. 5 is for illustration only. One or more of the components illustrated in FIG. 5 may be implemented in specialized circuitry configured to perform the noted functions or one or more of the components may be implemented by one or more processors executing instructions to perform the noted functions. Other embodiments of a procedure for random access could be used without departing from the scope of this disclosure.

In the example of FIG. 5, procedure 500 begins at step 510. At step 510, a UE (such as UE 116 of FIG. 1) receives a command from the network (e.g., from a BS, nodeB, gNB, etc., such as BS 102 of FIG. 1) to initiate a random access towards a cell. In some embodiments, the cell can be an Scell. In some embodiments, the cell can be an SpCell. In some embodiments, the command can be a PDCCH order. In some embodiments, the cell can be indicated in the command. In some embodiments, the cell is the cell from which the UE has received the command.

At step 520, upon receiving the command, the UE initiates a four step random access towards the cell.

At step 530, the UE selects a random access preamble. If a contention free random access preamble is included in the received command, the UE selects this random access preamble. Otherwise, the UE selects a random access preamble from contention based random access preambles of the indicated UL BWP of the cell. After making the selection, the UE transmits the selected random access preamble in a RACH occasion of the indicated UL BWP of the cell, and the UE starts a random access response timer upon transmitting the preamble.

At step 540, the UE monitors for a response to the transmitted preamble from the SpCell.

At step 560, if a CBRA preamble is transmitted, the UE monitors for a PDCCH addressed to an RA-RNTI while the random access response timer is running. If a PDCCH addressed to the RA-RNTI is received and a RAR scheduled by this PDCCH includes the identity of the preamble transmitted by the UE, the 4 step random access procedure is successfully completed. Otherwise, If a CFRA preamble is transmitted, the UE monitors for a PDCCH addressed to a C-RNTI while the random access response timer is running. If a PDCCH addressed to the C-RNTI is received scheduling a DL TB, and the DL TB scheduled includes an absolute TA command MAC CE (the absolute TA command MAC CE includes the absolute TA [not the TA adjustment]. The absolute TA command MAC CE may indicate the TAG associated with the TA), the 4 step random access procedure is successfully completed.

In in some embodiments, the UE may be in an RRC_INACTIVE state, and a small data transmission (SDT) procedure may be ongoing. In these embodiments, the UE may receive an RRCRelease message with resumeIndication in suspendConfig during the SDT procedure. Upon receving the RRCRelease message with resumeIndication, the UE terminates the SDT procedure, performs cell selection, and then then initiates an RRC connection resume procedure (where the resume cause is MT-Access). If an NR cell is selected during the cell selection (referred to hereinafter as “case 1”), the UE acquires the SIB1 of the selected cell and a RAN-based notification area (RNA) update may be triggered as part of the SIB1 processing. If the RNA update is triggered, an RRC connection resume will be performed for the RNA update (where the resume cause is rna-Update) and the RRC connection resume procedure (where the resume cause is MT-Access) is not performed even though the same was indicated in the received RRCRelease message. If a cell with a RAT other than NR is selected during the cell selection (referred to hereinafter as “case 2”), the RRC connection resume procedure (where the resume cause is MT-Access) is not performed, as the UE will perform an operation as defined for the other RAT.

It is not optimized to not perform the RRC connection resume procedure (where the resume cause is MT-Access) when the network explicity indicates for the UE to do so. Note that the UE is already in the RRC_INACTIVE state when it receives the RRCRelease message with resumeIndication in suspendConfig during the SDT procedure. In order to avoid not performing the RRC connection resume procedure (where the resume cause is MT-Access) due to case 1 and case 2, the UE should not perform cell selection when it receives an RRCRelease message with resumeIndication in suspendConfig during the SDT procedure.

In some embodiments, UE operation upon reception of the RRCRelease message by the UE may be as follows:

If the RRCRelease includes suspendConfig, and if the suspendConfig includes resumeIndication, the UE performs the actions as if the UE received a Paging message with the ue-Identity included in the PagingRecord matching the UE's stored fulll-RNTI, and the UE initiates an RRC connection resume procedure (where the resume cause is MT-Access). Otherwise, if the RRCRelease includes suspendConfig (and the suspendConfig does not include resumeIndication), if the UE is capable of L2 U2N Remote UE, the UE enters the RRC_INACTIVE state, and performs either cell selection, relay selection, or both; if the UE is not capable of L2 U2N Remote UE, the UE enters the RRC_INACTIVE state and performs cell selection.

Although FIG. 5 illustrates one example procedure for random access 500, various changes may be made to FIG. 5. For example, while shown as a series of steps, various steps in FIG. 5 could overlap, occur in parallel, occur in a different order, occur any number of times, be omitted, or replaced by other steps.

FIG. 6 illustrates another example procedure for random access 600 according to embodiments of the present disclosure. An embodiment of the procedure illustrated in FIG. 6 is for illustration only. One or more of the components illustrated in FIG. 6 may be implemented in specialized circuitry configured to perform the noted functions or one or more of the components may be implemented by one or more processors executing instructions to perform the noted functions. Other embodiments of a procedure for random access could be used without departing from the scope of this disclosure.

In the example of FIG. 6, procedure 600 begins at step 610. At step 610, a UE (such as UE 116 of FIG. 1) may receive configuration of multiple UL BWPs for an uplink carrier of a cell from a base station or gNB (such as BS 102 of FIG. 1). For example, the configuration may be received in an RRC message or system information. The uplink carrier can be a normal uplink (NUL) or supplementary uplink (SUL). In some embodiments, the UL BWP configuration may include a random access configuration. The cell can be a serving cell or non-serving cell, and the cell can be an SpCell or SCell.

At step 620, a random access procedure is initiated for the cell, triggered by one or more events. For example, the random access procedure may be triggered due to data arrival in an RRC_IDLE/RRC_INACTIVE state, due to a scheduling request (SR)/buffer status reporting (BSR), or due to an emergency call.

At step 630, upon initiation of the random access procedure, the UE first selects the carrier (SUL or NUL). If the carrier to use for the random access procedure is explicitly signaled by the gNB, the UE selects the signaled carrier for performing the random access procedure. If [1] the carrier to use for the random access procedure is not explicitly signaled by the gNB, [2] the cell for the random access procedure is configured with SUL, and [3] the RSRP of the downlink pathloss reference is less than rsrp-ThresholdSSB-SUL, the UE selects the SUL carrier for performing the random access procedure. Otherwise, the UE selects the NUL carrier for performing the random access procedure. The UL carrier selection can be skipped if the cell is configured with only one UL carrier and the UE uses this UL carrier for random access.

At step 640, the UE selects a RACH occasion amongst all RACH occasions (excluding occasions overlapping with a measurement gap and/or excluding occasions not permitted by a RACH occasion mask index) of all the UL BWPs of the selected UL carrier, configured with RACH occasions or configured with a random access configuration. The UE may select the RACH occasion randomly or may select the first available RACH occasions amongst all the RACH occasions of the UL BWPs configured with RACH occasions or configured with a random access configuration. If the selected RACH occasion belongs to a UL BWP different from the active UL BWP, the UE may switch the active UL BWP to the UL BWP to which the selected RACH occasion belongs. If the cell for which the random access procedure is initiated is an SpCell, the UE may also switch the active DL BWP to the DL BWP with same the ID as the UL BWP whose RACH occasion is selected by the UE.

At step 650, the UE transmits the random access preamble in the selected RACH occasion.

Although FIG. 6 illustrates one example procedure for random access 600, various changes may be made to FIG. 6. For example, while shown as a series of steps, various steps in FIG. 6 could overlap, occur in parallel, occur in a different order, occur any number of times, be omitted, or replaced by other steps.

FIG. 7 illustrates another example procedure for random access 700 according to embodiments of the present disclosure. An embodiment of the procedure illustrated in FIG. 7 is for illustration only. One or more of the components illustrated in FIG. 7 may be implemented in specialized circuitry configured to perform the noted functions or one or more of the components may be implemented by one or more processors executing instructions to perform the noted functions. Other embodiments of a procedure for random access could be used without departing from the scope of this disclosure.

In the example of FIG. 7, procedure 700 begins at step 710. At step 710, a UE (such as UE 116 of FIG. 1) may receive configuration of multiple UL BWPs for an uplink carrier of a cell from a base station or gNB (such as BS 102 of FIG. 1). For example, the configuration may be received in an RRC message or system information. The uplink carrier can be a normal uplink (NUL) or supplementary uplink (SUL). In some embodiments, the UL BWP configuration may include a random access configuration. The cell can be a serving cell or non-serving cell, and the cell can be an SpCell or SCell. The UE may receive a congestion/contention level (or congestion/contention probability) for the UL BWP from the base station or gNB.

At step 720, a random access procedure is initiated for the cell, triggered by one or more events. For example, the random access procedure may be triggered due to data arrival in an RRC_IDLE/RRC_INACTIVE state, due to an SR/BSR, or due to an emergency call.

At step 730 upon initiation of the random access procedure, the UE first selects the carrier (SUL or NUL). If the carrier to use for the random access procedure is explicitly signaled by the gNB, the UE selects the signaled carrier for performing the random access procedure. If [1] the carrier to use for the random access procedure is not explicitly signaled by the gNB, [2] the cell for the random access procedure is configured with SUL, and [3] the RSRP of the downlink pathloss reference is less than rsrp-ThresholdSSB-SUL, the UE selects the SUL carrier for performing the random access procedure. Otherwise, the UE selects the NUL carrier for performing the random access procedure. The UL carrier selection can be skipped if the cell is configured with only one UL carrier and the UE uses this UL carrier for random access.

At step 740, for the selected UL carrier, the UE selects an UL BWP configured with RACH occasions or configured with a random access configuration and with least congestion/contention level (or congestion/contention probability). The congestion/contention level (or congestion/contention probability) for the UL BWP can be signaled by the gNB for example in an RRC message or system information.

At step 750, the UE selects a RACH occasion amongst all RACH occasions (excluding occasions overlapping with a measurement gap and/or excluding occasions not permitted by a RACH occasion mask index) of the selected UL BWP. The UE may select the RACH occasion randomly or may select the first available RACH occasion amongst all RACH occasions of the selected UL BWP. If the selected UL BWP is different from the active UL BWP, the UE may switch the active UL BWP to the selected UL BWP. If the cell for which the random access procedure is initiated is an SpCell, the UE may also switch the active DL BWP to DL BWP with the same ID as the selected UL BWP.

At step 760, the UE transmits a random access preamble in the selected RACH occasion.

Although FIG. 7 illustrates one example procedure for random access 700, various changes may be made to FIG. 7. For example, while shown as a series of steps, various steps in FIG. 7 could overlap, occur in parallel, occur in a different order, occur any number of times, be omitted, or replaced by other steps.

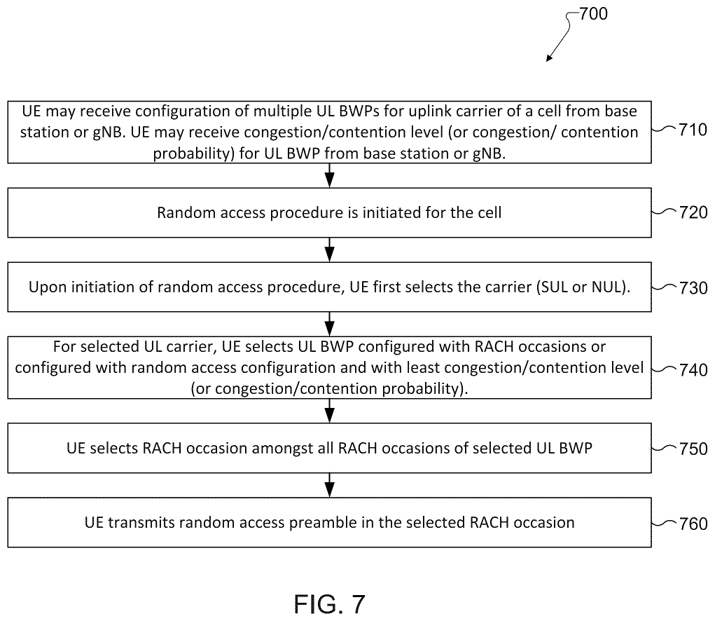

FIG. 8 illustrates another example procedure for random access 800 according to embodiments of the present disclosure. An embodiment of the procedure illustrated in FIG. 8 is for illustration only. One or more of the components illustrated in FIG. 8 may be implemented in specialized circuitry configured to perform the noted functions or one or more of the components may be implemented by one or more processors executing instructions to perform the noted functions. Other embodiments of a procedure for random access could be used without departing from the scope of this disclosure.

In the example of FIG. 8, procedure 800 begins at step 810. At step 810, a UE (such as UE 116 of FIG. 1) may receive configuration of multiple UL BWPs for an uplink carrier of a cell from a base station or gNB (such as BS 102 of FIG. 1). For example, the configuration may be received in an RRC message or system information. The uplink carrier can be a normal uplink (NUL) or supplementary uplink (SUL). In some embodiments, the UL BWP configuration may include a random access configuration. The cell can be a serving cell or non-serving cell, and the cell can be an SpCell or SCell.

At step 820, a random access procedure is initiated for the cell, triggered by one or more events. For example, the random access procedure may be triggered due to data arrival in an RRC_IDLE/RRC_INACTIVE state, due to an SR/BSR, or due to an emergency call.

At step 830 upon initiation of the random access procedure, the UE first selects the carrier (SUL or NUL). If the carrier to use for the random access procedure is explicitly signaled by the gNB, the UE selects the signaled carrier for performing the random access procedure. If [1] the carrier to use for the random access procedure is not explicitly signaled by the gNB, [2] the cell for the random access procedure is configured with SUL, and [3] the RSRP of the downlink pathloss reference is less than rsrp-ThresholdSSB-SUL, the UE selects the SUL carrier for performing the random access procedure. Otherwise, the UE selects the NUL carrier for performing the random access procedure. The UL carrier selection can be skipped if the cell is configured with only one UL carrier and the UE uses this UL carrier for random access.

At step 840, for the selected UL carrier, the UE selects an UL BWP configured with RACH occasions or configured with a random access configuration and associated with a feature/feature combination applicable for the random access.

At step 850, The UE selects a RACH occasion amongst all RACH occasions (excluding occasions overlapping with a measurement gap and/or excluding occasions not permitted by a RACH occasion mask index) of the selected UL BWP. The UE may select a RACH occasion randomly or may select the first available RACH occasion amongst all RACH occasions of the selected UL BWP. If the selected UL BWP is different from the active UL BWP, the UE may switch the active UL BWP to the selected UL BWP. If the cell for which the random access procedure is initiated is an SpCell, the UE may also switch the active DL BWP to DL BWP with the same ID as the selected UL BWP.

At step 860, the UE transmits a random access preamble in the selected RACH occasion.

Although FIG. 8 illustrates one example procedure for random access 800, various changes may be made to FIG. 8. For example, while shown as a series of steps, various steps in FIG. 8 could overlap, occur in parallel, occur in a different order, occur any number of times, be omitted, or replaced by other steps.

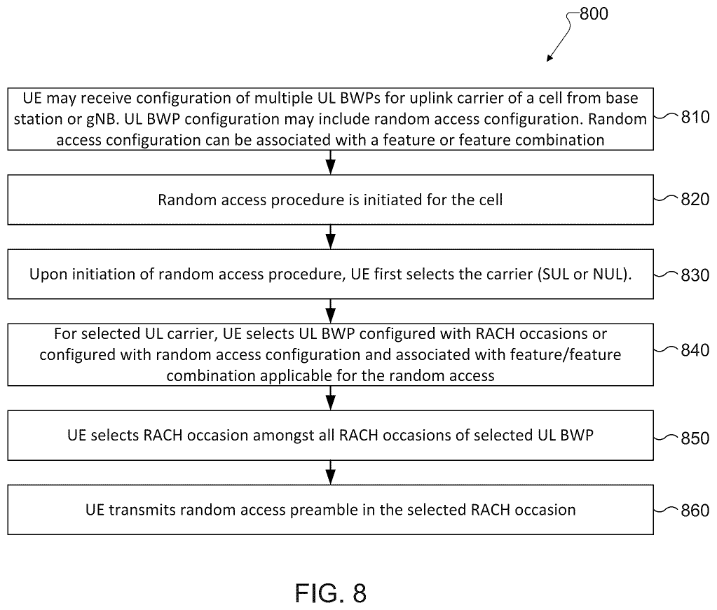

FIG. 9 illustrates another example procedure for random access 900 according to embodiments of the present disclosure. An embodiment of the procedure illustrated in FIG. 9 is for illustration only. One or more of the components illustrated in FIG. 9 may be implemented in specialized circuitry configured to perform the noted functions or one or more of the components may be implemented by one or more processors executing instructions to perform the noted functions. Other embodiments of a procedure for random access could be used without departing from the scope of this disclosure.

In the example of FIG. 9, procedure 900 begins at step 910. At step 910, a UE (such as UE 116 of FIG. 1) may receive configuration of multiple UL BWPs for an uplink carrier of a cell from a base station or gNB (such as BS 102 of FIG. 1). For example, the configuration may be received in an RRC message or system information. The uplink carrier can be a normal uplink (NUL) or supplementary uplink (SUL). In some embodiments, the UL BWP configuration may include a random access configuration. The cell can be a serving cell or non-serving cell, and the cell can be an SpCell or SCell.

At step 920, a random access procedure is initiated for the cell, triggered by one or more events. For example, the random access procedure may be triggered due to data arrival in an RRC_IDLE/RRC_INACTIVE state, due to an SR/BSR, or due to an emergency call.

At step 930 upon initiation of the random access procedure, the UE first selects the carrier (SUL or NUL). If the carrier to use for the random access procedure is explicitly signaled by the gNB, the UE selects the signaled carrier for performing the random access procedure. If [1] the carrier to use for the random access procedure is not explicitly signaled by the gNB, [2] the cell for the random access procedure is configured with SUL, and [3] the RSRP of the downlink pathloss reference is less than rsrp-ThresholdSSB-SUL, the UE selects the SUL carrier for performing the random access procedure. Otherwise, the UE selects the NUL carrier for performing the random access procedure. The UL carrier selection can be skipped if the cell is configured with only one UL carrier and the UE uses this UL carrier for random access.

At step 940, for the selected UL carrier, the UE selects an UL BWP configured with RACH occasions or configured with a random access configuration.

In one embodiment, if there are multiple UL BWPs configured with RACH occasions or configured with a random access configuration, the UE selects an UL BWP based on the UE's UE type. Each UL BWP can be associated with one or more UE types, and this association may be configured by the gNB or base station for example via an RRC message or system information.

In one embodiment, if there are multiple UL BWPs configured with RACH occasions or configured with a random access configuration, the UE selects an UL BWP based on the UE's UE identity. For example, the UE may select an UL BWP of the UL BWPs whose UL BWP ID=UE identity mod number. Each UL BWP can be associated with a range of UE identities, and this association may be configured by the gNB or base station for example via an RRC message or system information. The UE selects an UL BWP associated with this UE identity.

In one embodiment, if there are multiple UL BWPs configured with RACH occasions or configured with a random access configuration, the UE selects an UL BWP based on the UE's access category or access class. Each UL BWP can be associated with one or more access category or access class, and this association may be configured by the gNB or base station for example via an RRC message or system information. The UE selects an UL BWP associated with it access category or access class.

In one embodiment, if there are multiple UL BWPs configured with RACH occasions or configured with a random access configuration, the UE selects an UL BWP based on the UE's reason for accessing the cell. The reason for accessing the cell can be mo-signaling, mo-data, mt-access, sdt, MBS, D2D, V2X, XR, etc. Each UL BWP can be associated with one or more access reasons, and this association may be configured by the gNB or base station for example via an RRC message or system information.

In one embodiment, if there are multiple UL BWPs configured with RACH occasions or configured with a random access configuration, each UL BWP is mapped to a subset of SSBs/CSI-RSs transmitted in cell and this association may be configured by the gNB or base station for example via an RRC message or system information. The UE may first select an SSB/CSI-RS with an SS-RSRP/CSI-RSRP above an SSB-threshold/CSI-RS threshold. The UE then selects an UL BWP associated with the selected SSB.

In one embodiment, if there are multiple UL BWPs configured with RACH occasions or configured with a random access configuration, at least one RACH configuration can be associated with a Quality of Service (QOS) level/QoS class/QoS flow identifier (QFI)/QoS class identifier (QCI), and this association may be configured by the gNB or base station for example via an RRC message or system information. If the random access is triggered due to data arrival in an RRC_IDLE/RRC_INACTIVE state or triggered due to an SR/BSR, the UE may select an UL BWP with a RACH configuration associated with a QoS level/QoS class/QFI/QCI/priority/packet delay budget of data. The UE selects a RACH occasion amongst all RACH occasion (excluding occasions overlapping with a measurement gap and/or excluding occasions not permitted by a RACH occasion mask index) of this RACH configuration/selected BWP.

In one embodiment, if there are multiple UL BWPs configured with RACH occasions or configured with a random access configuration, at least one RACH configuration/UL BWP can be associated with emergency call, and this association may be configured by the gNB or base station for example via an RRC message or system information. If the random access is triggered due to an emergency call, the UE may select an UL BWP/UL BWP with a RACH configuration associated with emergency call. The UE selects a RACH occasion amongst all RACH occasions (excluding occasions overlapping with a measurement gap and/or excluding occasions not permitted by a RACH occasion mask index) of this RACH configuration/selected BWP.

In one embodiment, if there are multiple UL BWPs configured with RACH occasions or configured with a random access configuration, a paging message or a PDCCH scheduling the paging message or la ow power wakeup signal may indicate an UL BWP to be used for random access. The UL BWP can be indicated by including a BWP ID in the paging message. If the random access is initiated due to paging (i.e., the UE is accessing the cell for connection setup/resume in response to a paging), the UE selects the UL BWP indicated in the paging message or the PDCCH scheduling the paging message or the low power wakeup signal.

At step 950, the UE selects a RACH occasion amongst all RACH occasions (excluding occasions overlapping with a measurement gap and/or excluding occasions not permitted by a RACH occasion mask index) of the selected UL BWP. The UE may select a RACH occasion randomly or may select the first available RACH occasion amongst all RACH occasions of selected UL BWP. If the selected UL BWP is different from the active UL BWP, the UE may switch the active UL BWP to the selected UL BWP. If the cell for which the random access procedure is initiated is an SpCell, the UE may also switch the active DL BWP to DL BWP with the same ID as the selected UL BWP.

At step 960, the UE transmits a random access preamble in the selected RACH occasion.

In some embodiments, if the UE intends to perform random access using an UL BWP different from the current active UL BWP (or the UL BWP selected [as explained above herein]) is different from current active UL BWP), the UE can indicate a RACH target BWP index to the network (for example, using SR, PUCCH, MAC CE, etc.) before the UE performs the RACH in the different BWP.

In some embodiments, the UE may receive a 4 step random access configuration of a cell from the gNB. The configuration may include multiple preambleReceivedTargetPower configurations. Each preambleReceivedTargetPower is associated with a subset (the subset can be one or more SSBs) of transmitted SSBs in the cell. The SSBs may be identified by SSB index. In some embodiments, the transmitted SSBs in the cell may be signaled in an RRC message or system information.

During the 4 step random access procedure, the UE selects an SSB for the random access attempt. The UE then selects a RACH occasion corresponding to the selected SSB. The UE then transmits a random access preamble in the selected RACH occasion. The random access preamble is transmitted using a transmission power which is calculated based on PREAMBLE_RECEIVED_TARGET_POWER. PREAMBLE_RECEIVED_TARGET_POWER is determined as follows:

$$PREAMBLE\_RECEIVED \_TARGET \_POWER = preambleReceivedTargetPower of selected SSB + DELTA\_PREAMBLE + ( PREAMBLE\_POWER \_RAMPING \_COUNTER - 1 ) \times PREAMBLE\_POWER \_RAMPING \_STEP + POWER\_OFFSET \_ 2 STEP\_RA .$$

PREAMBLE_POWER_RAMPING_COUNTER is initialized to one when random access procedure is initiated. For each random access attempt (except the first one), PREAMBLE_POWER_RAMPING_COUNTER is incremented based on following rule: if [1] the notification of suspending power ramping counter has not been received from lower layers, and [2] if a listen before talk (LBT) failure indication was not received from lower layers for the last random access preamble transmission, and [3] if the SSB or CSI-RS selected is not changed from the selection in the last random access preamble transmission, and [4] if the random access procedure is not initiated by the PDCCH order for an lower layer triggered mobility (LTM) candidate cell, the UE increments PREAMBLE_POWER RAMPING_COUNTER by 1.

PREAMBLE_POWER_RAMPING_STEP is set to the power ramping step parameter received in the 4 step random access configuration.

DELTA_PREAMBLE is pre-defined for each preamble format. The preamble format is received in in the 4 step random access configuration.

POWER_OFFSET_2STEP_RA is set to 0 dB when the random access procedure is initiated.

In some embodiments, the UE may receive a 2 step random access configuration of a cell from the gNB. The configuration may include multiple msgA-PreambleReceivedTargetPower configurations. Each msgA-PreambleReceivedTargetPower may be associated with a subset (the subset can be one or more SSBs) of transmitted SSBs in the cell. The SSBs may be identified by an SSB index. In some embodiments, the transmitted SSBs in the cell may be signaled in an RRC message or system information.

During the 2-step random access procedure UE selects an SSB for the random access attempt. The UE then selects a RACH occasion corresponding to the selected SSB. The UE then transmits a random access preamble in the selected RACH occasion. The random access preamble is transmitted using transmission power which is calculated based on PREAMBLE_RECEIVED_TARGET_POWER. PREAMBLE_RECEIVED_TARGET_POWER is determined as follows:

$$PREAMBLE\_RECEIVED \_TARGET \_POWER = msgA - PreambleReceivedTargetPower of selected SSB + DELTA\_PREAMBLE + ( PREAMBLE\_POWER \_RAMPING \_COUNTER - 1 ) \times PREAMBLE\_POWER \_RAMPING \_STEP .$$

PREAMBLE_POWER_RAMPING_COUNTER is initialized to one when random access procedure is initiated. For each random access attempt (except the first one), PREAMBLE_POWER_RAMPING_COUNTER is incremented based on following rule: if [1] the notification of suspending power ramping counter has not been received from lower layers, and [2] if an LBT failure indication was not received from lower layers for the last MsgA random access preamble transmission, and [3] if the SSB selected is not changed from the selection in the last random access Preamble transmission, the UE increments PREAMBLE_POWER_RAMPING_COUNTER by 1.

PREAMBLE_POWER_RAMPING_STEP is set to power ramping step parameter received in 2 step random access configuration.

DELTA_PREAMBLE is pre-defined for each preamble format. Preamble format is received in in 2 step random access configuration.

The RA type can be switched from 2-step to 4-step. If RA_TYPE is switched from 2-stepRA to 4-stepRA during the random access procedure, The UE sets POWER_OFFSET_2STEP_RA to (PREAMBLE_POWER_RAMPING_COUNTER−1)×(MSGA_PREAMBLE_POWER_RAMPING_STEP−PREAMBLE_POWER_RAMPING_STEP). This POWER_OFFSET_2STEP_RA is then used to calculate PREAMBLE_RECEIVED_TARGET_POWER during the 4 step RA.

Although FIG. 9 illustrates one example procedure for random access 900, various changes may be made to FIG. 9. For example, while shown as a series of steps, various steps in FIG. 9 could overlap, occur in parallel, occur in a different order, occur any number of times, be omitted, or replaced by other steps.

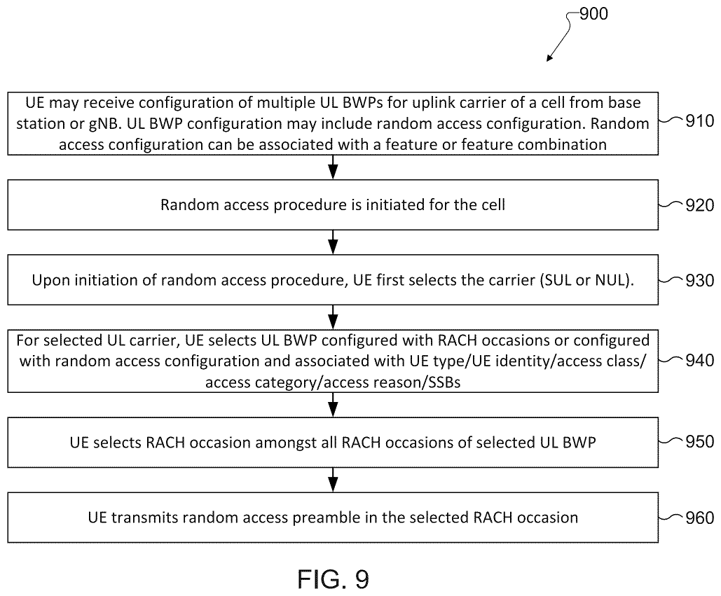

FIG. 10 illustrates an example method for random access in a cell supporting multiple bandwidth parts 1000 according to embodiments of the present disclosure. An embodiment of the method illustrated in FIG. 10 is for illustration only. One or more of the components illustrated in FIG. 10 may be implemented in specialized circuitry configured to perform the noted functions or one or more of the components may be implemented by one or more processors executing instructions to perform the noted functions. Other embodiments of a method for random access in a cell supporting multiple bandwidth parts could be used without departing from the scope of this disclosure.

In the example of FIG. 10, method 1000 begins at step 1010. At step 1010, a UE (such as UE 116 of FIG. 1) receives, from a BS (such as BS 102 of FIG. 1), UL BWP configurations for a plurality of UL BWPs of a cell, each of the UL BWP configurations including an RA configuration.

At step 1020, the UE determines UL BWP selection information.

At step 1030, the UE selects, based on the UL BWP selection information, an UL BWP from the plurality UL BWPs for an RA procedure.

At step 1040, the UE transmits an RA preamble in a RACH occasion of the selected UL BWP.

In some embodiments, the UE may receive, from the BS, congestion information for the plurality of UL BWPs. In these embodiments, the congestion information may be the UL BWP selection information, and the UE may select an UL BWP from the plurality of UL BWPs with least congestion for the RA procedure.

In some embodiments, the UE may receive, from the BS, a message including one of a command to initiate an RA, a paging message, a paging DCI, and an LPWUS. In these embodiments, the message may indicate an UL BWP from the plurality of UL BWPs, the UL BWP selection information may be the indicated UL BWP, and the UE may select the indicated UL BWP for the RA procedure.

In some embodiments, the UE may select a RACH occasion amongst RACH occasions allocated to the plurality of UL BWPs. In these embodiments, the UL BWP selection information may be the selected RACH occasion, and the UE may select an UL BWP of the selected RACH occasion for transmission of the RA preamble.

In some embodiments, the UL BWP selection information may be at least one of a UE type, UE identity, access category, access reason, SSB/CSI RS, and QoS information. In these embodiments, the UE may select an UL BWP from the plurality of UL BWPs associated with the at least one of the UE type, UE identity, access category, access reason, SSB/CSI RS, and QoS information.

In some embodiments, the UE may determine whether the selected UL BWP is different from an active UL BWP, and in response to a determination that the selected UL BWP is different from the active UL BWP, switch the active UL BWP to the selected UL BWP.

In some embodiments, the RA configuration for the selected UL BWP may include a plurality of preamble ReceivedTargetPower configurations, where each preamble ReceivedTargetPower is associated with a subset of transmitted SSBs in the cell. In these embodiments, the UE may select an SSB from the transmitted SSBs, and determine, based on the preambleReceivedTargetPower configuration associated with the selected SSB, a preamble received target power for the RA preamble transmission.

In some embodiments, the RA procedure may be a 4 step RA procedure, and the RA preamble may be transmitted as part of the 4 step RA procedure. In these embodiments, the UE may determine whether the RA preamble is for a CBRA or CFRA procedure. In response to a determination that the RA preamble is for a CBRA procedure, the UE may, after transmission of the RA preamble, monitor for a PDCCH addressed to an RA-RNTI, and when the PDCCH addressed to the RA-RNTI is received and a RAR scheduled by the PDCCH includes an identity of the RA preamble, declare that the 4 step RA procedure is successfully completed. In response to a determination that the RA preamble is for a CFRA procedure, the UE may, after transmission of the RA preamble, monitor for a PDCCH addressed to a C-RNTI, and when [1] the PDCCH addressed to the C-RNTI is received, [2] the received PDCCH schedules DL TB, and [3] the DL TB includes an absolute TA command MAC CE, declare that the 4 step RA procedure is successfully completed.

Although FIG. 10 illustrates one example method for random access in a cell supporting multiple bandwidth parts 1000, various changes may be made to FIG. 10. For example, while shown as a series of steps, various steps in FIG. 10 could overlap, occur in parallel, occur in a different order, occur any number of times, be omitted, or replaced by other steps.

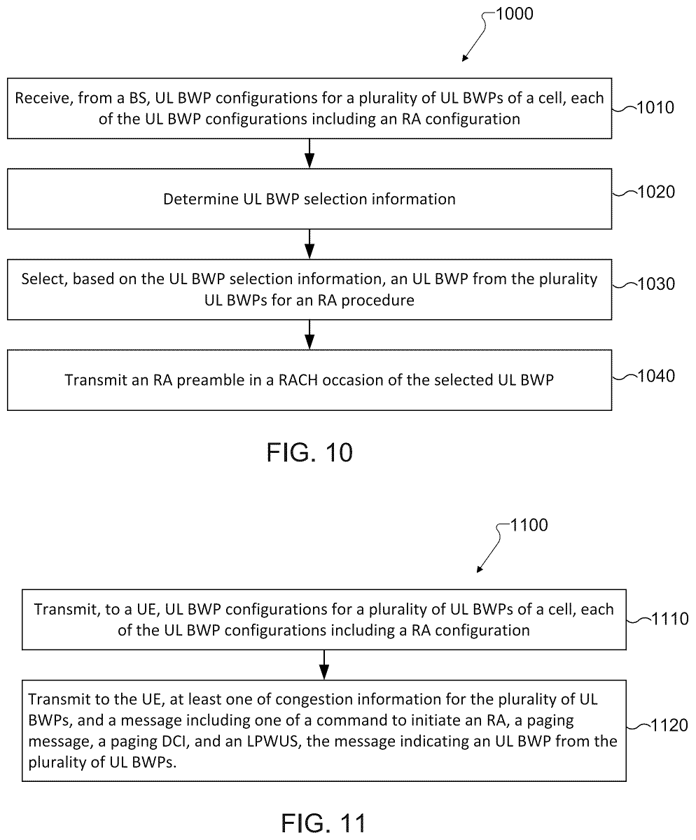

FIG. 11 illustrates an example method for network initiated random access 1100 according to embodiments of the present disclosure. An embodiment of the method illustrated in FIG. 11 is for illustration only. One or more of the components illustrated in FIG. 11 may be implemented in specialized circuitry configured to perform the noted functions or one or more of the components may be implemented by one or more processors executing instructions to perform the noted functions. Other embodiments of a method for network initiated random access could be used without departing from the scope of this disclosure.

In the example of FIG. 11, method 1100 begins at step 1110. At step 1110, a BS (such as BS 102 of FIG. 1) transmit, to a UE (such as UE 116 of FIG. 1), UL BWP configurations for a plurality of UL BWPs of a cell, each of the UL BWP configurations including an RA configuration.

In some embodiments, the RA configuration for at least one UL BWP from the plurality of UL BWPs may include a plurality of preamble ReceivedTargetPower configurations, and each preambleReceivedTargetPower may be associated with a subset of transmitted synchronization signal blocks (SSBs) in the cell.

At step 1120, the BS transmits, to the UE, at least one of congestion information for the plurality of UL BWPs, and a message including one of a command to initiate an RA, a paging message, a paging DCI, and an LPWUS, the message indicating an UL BWP from the plurality of UL BWPs.

Although FIG. 11 illustrates one example method for network initiated random access 1100, various changes may be made to FIG. 11. For example, while shown as a series of steps, various steps in FIG. 11 could overlap, occur in parallel, occur in a different order, occur any number of times, be omitted, or replaced by other steps.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

What is claimed is:

1. A user equipment (UE) comprising:
a transceiver configured to receive, from a base station (BS), uplink (UL) bandwidth part (BWP) configurations for a plurality of UL BWPs of a cell, each of the UL BWP configurations including a random access (RA) configuration;
a processor operatively coupled to the transceiver, the processor configured to:
determine UL BWP selection information; and
select, based on the UL BWP selection information, an UL BWP from the plurality UL BWPs for an RA procedure,
wherein the transceiver is further configured to transmit an RA preamble in an RA channel (RACH) occasion of the selected UL BWP.

2. The UE of claim 1, wherein:
the transceiver is further configured to receive, from the BS, congestion information for the plurality of UL BWPs;
the congestion information is the UL BWP selection information; and
the processor is further configured to select an UL BWP from the plurality of UL BWPs with least congestion for the RA procedure.

3. The UE of claim 1, wherein:
the transceiver is further configured to receive, from the BS, a message including one of:
a command to initiate an RA;
a paging message;
a paging downlink control information (DCI); and
a low power wakeup signal (LPWUS);
the message indicates an UL BWP from the plurality of UL BWPs;
the UL BWP selection information is the indicated UL BWP; and
the processor is further configured to select the indicated UL BWP for the RA procedure.

4. The UE of claim 1, wherein:
the processor is further configured to select a RACH occasion amongst RACH occasions allocated to the plurality of UL BWPs;
the UL BWP selection information is the selected RACH occasion; and
the processor is further configured to select an UL BWP of the selected RACH occasion for transmission of the RA preamble.

5. The UE of claim 1, wherein:
the UL BWP selection information is a feature or feature combination applicable for the RA procedure; and
the processor is further configured to select an UL BWP from the plurality of UL BWPs associated with the feature or feature combination for the RA procedure.

6. The UE of claim 1, wherein:
the UL BWP selection information is at least one of a UE type, UE identity, access category, access reason, synchronization signal block (SSB)/channel state information (CSI) reference signal (RS), and quality of service (QOS) information; and
the processor is further configured to select an UL BWP from the plurality of UL BWPs associated with the at least one of the UE type, UE identity, access category, access reason, SSB/CSI RS, and QoS information.

7. The UE of claim 1, wherein the processor is further configured to:
determine whether the selected UL BWP is different from an active UL BWP; and
in response to a determination that the selected UL BWP is different from the active UL BWP, switch the active UL BWP to the selected UL BWP.

8. The UE of claim 1, wherein:
the RA configuration for the selected UL BWP includes a plurality of preambleReceivedTargetPower configurations;
each preambleReceivedTargetPower is associated with a subset of transmitted synchronization signal blocks (SSBs) in the cell; and
the processor is further configured to:
select an SSB from the transmitted SSBs; and
determine, based on the preamble ReceivedTargetPower configuration associated with the selected SSB, a preamble received target power for the RA preamble transmission.

9. The UE of claim 1, wherein:
the RA procedure is a 4 step RA procedure;
the transceiver is further configured to transmit the RA preamble as part of the 4 step RA procedure; and
the processor is further configured to:
determine whether the RA preamble is for a contention based RA (CBRA) or contention free RA (CFRA) procedure;
in response to a determination that the RA preamble is for a CBRA procedure:
after transmission of the RA preamble, monitor for a physical downlink control channel (PDCCH) addressed to an RA-radio network temporary identifier (RA-RNTI);
when the PDCCH addressed to the RA-RNTI is received and a RA response (RAR) scheduled by the PDCCH includes an identity of the RA preamble, declare that the 4 step RA procedure is successfully completed; and
in response to a determination that the RA preamble is for a CFRA procedure:
after transmission of the RA preamble, monitor for a PDCCH addressed to a cell-radio network temporary identifier (C-RNTI); and
when [1] the PDCCH addressed to the C-RNTI is received, [2] the received PDCCH schedules a downlink (DL) transport block (TB), and [3] the DL TB includes an absolute timing advance (TA) command medium access control (MAC) control element (CE), declare that the 4 step RA procedure is successfully completed.

10. A base station (BS) comprising:
a processor; and
a transceiver operatively coupled to the processor, the transceiver configured to:
transmit, to a user equipment (UE), uplink (UL) bandwidth part (BWP) configurations for a plurality of UL BWPs of a cell, each of the UL BWP configurations including a random access (RA) configuration;
transmit, to the UE, at least one of:
congestion information for the plurality of UL BWPs; and
a message including one of:
a command to initiate an RA;
a paging message;
a paging downlink control information (DCI); and
a low power wakeup signal (LPWUS),
wherein the message indicates an UL BWP from the plurality of UL BWPs.

11. The BS of claim 10, wherein:
the RA configuration for at least one UL BWP from the plurality of UL BWPs includes a plurality of preamble ReceivedTargetPower configurations; and
each preambleReceivedTargetPower is associated with a subset of transmitted synchronization signal blocks (SSBs) in the cell.

12. A method of operating a user equipment (UE), the method comprising:
receiving, from a base station (BS), uplink (UL) bandwidth part (BWP) configurations for a plurality of UL BWPs of a cell, each of the UL BWP configurations including a random access (RA) configuration;
determining UL BWP selection information;
selecting, based on the UL BWP selection information, an UL BWP from the plurality UL BWPs for an RA procedure; and
transmitting an RA preamble in an RA channel (RACH) occasion of the selected UL BWP.

13. The method of claim 12, further comprising:
receiving, from the BS, congestion information for the plurality of UL BWPs, wherein the congestion information is the UL BWP selection information; and
selecting an UL BWP from the plurality of UL BWPs with least congestion for the RA procedure.

14. The method of claim 12, further comprising:
receiving, from the BS, a message including one of:
a command to initiate an RA;
a paging message;
a paging downlink control information (DCI); and
a low power wakeup signal (LPWUS),
wherein, the message indicates an UL BWP from the plurality of UL BWPs, and the UL BWP selection information is the indicated UL BWP; and
selecting the indicated UL BWP for the RA procedure.

15. The method of claim 12, further comprising:
selecting a RACH occasion amongst RACH occasions allocated to the plurality of UL BWPs, wherein the UL BWP selection information is the selected RACH occasion; and
selecting an UL BWP of the selected RACH occasion for transmission of the RA preamble.

16. The method of claim 12, wherein:
the UL BWP selection information is a feature or feature combination applicable for the RA procedure; and
the method further comprises selecting an UL BWP from the plurality of UL BWPs associated with the feature or feature combination for the RA procedure.

17. The method of claim 12, wherein:
the UL BWP selection information is at least one of a UE type, UE identity, access category, access reason, synchronization signal block (SSB)/channel state information (CSI) reference signal (RS), and quality of service (QOS) information; and
the method further comprises selecting an UL BWP from the plurality of UL BWPs associated with the at least one of the UE type, UE identity, access category, access reason, SSB/CSI RS, and QoS information.

18. The method of claim 12, further comprising:
determining whether the selected UL BWP is different from an active UL BWP; and
in response to a determination that the selected UL BWP is different from the active UL BWP, switching the active UL BWP to the selected UL BWP.

19. The method of claim 12, wherein:
the RA configuration for the selected UL BWP includes a plurality of preamble ReceivedTargetPower configurations;
each preambleReceivedTargetPower is associated with a subset of transmitted synchronization signal blocks (SSBs) in the cell; and
the method further comprises:
selecting an SSB from the transmitted SSBs; and
determining, based on the preamble ReceivedTargetPower configuration associated with the selected SSB, a preamble received target power for the RA preamble transmission.

20. The method of claim 12, wherein:
the RA procedure is a 4 step RA procedure;
the RA preamble is transmitted as part of the 4 step RA procedure; and
the method further comprises:
determining whether the RA preamble is for a contention based RA (CBRA) or contention free RA (CFRA) procedure;
in response to a determination that the RA preamble is for a CBRA procedure:
after transmission of the RA preamble, monitoring for a physical downlink control channel (PDCCH) addressed to an RA-radio network temporary identifier (RA-RNTI);
when the PDCCH addressed to the RA-RNTI is received and a RA response (RAR) scheduled by the PDCCH includes an identity of the RA preamble, declaring that the 4 step RA procedure is successfully completed; and
in response to a determination that the RA preamble is for a CFRA procedure:
after transmission of the RA preamble, monitoring for a PDCCH addressed to a cell-radio network temporary identifier (C-RNTI); and
when [1] the PDCCH addressed to the C-RNTI is received, [2] the received PDCCH schedules a downlink (DL) transport block (TB), and [3] the DL TB includes an absolute timing advance (TA) command medium access control (MAC) control element (CE), declaring that the 4 step RA procedure is successfully completed.
